(19) United States
(12) Patent Application Publication
(10) Pub. No.: US 2008/0131058 A1
(43) Pub. Date: Jun. 5, 2008

(54) COMBINED OPTICAL AND ELECTRICAL CONNECTOR

(75) Inventors: Masayuki TSUNODA, Tokyo (JP); Tsuyoshi Wakisaka, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: The Furukawa Electric Co, Ltd., Tokyo (JP)

(21) Appl. No.: 11/876,308

(22) Filed: Oct. 22, 2007

Related U.S. Application Data
(63) Continuation of application No. PCT/JP07/51524, filed on Jan. 30, 2007.

(30) Foreign Application Priority Data
Jan. 31, 2006 (JP) 2006-022344

(51) Int. Cl. G02B 6/38

(52) U.S. Cl. 385/75

(57) ABSTRACT

The present invention relates to a combined optical and electrical connector, and more specifically relates to a combined optical and electrical connector having a structure in which an optical connector and an electrical connector are integrated. Specifically, it includes a receptacle housing (3) to which a plug is attached from the outside, a transmitting-side module housing section (8c) for housing a transmitting-side module (14) at the back side of the receptacle housing, a receiving-side module housing section (9c) for housing a receiving-side module (11), the receiving-side module housing section being arranged in a location adjacent to the transmitting-side module housing section at the back side of the receptacle housing, an electrical terminal (6) projecting to the back side of the receptacle housing, and an integrated shield case (16) surrounding the receiving-side module housing section, the transmitting-side module housing section, and the electrical terminal.

### CROSS-REFERENCE TO RELATED APPLICATIONS

This application is a continuation application of PCT/JP07/051,524, filed Jan. 30, 2007, which is based upon and claims the benefit of priority from Japan Patent Application No. 2006-022344, filed Jan. 31, 2006, the entire contents of each of which are incorporated herein by reference.

### TECHNICAL FIELD

The present invention relates to a combined optical and electrical connector, and more specifically relates to a combined optical and electrical connector having a structure in which an optical connector and an electrical connector are integrated.

### BACKGROUND ART

In recent years, vehicles are equipped with an apparatus for processing and managing various information including displaying a vehicle position on a map using a car-navigation system, and grasping a traffic congestion state of vehicles using an intelligent transport system (ITS) and so on. With the processing of such information, optical information transmission using an optical fiber as a mass information transmission method is increasingly performed also within vehicles, such as a car. In optical communications, an optical signal is inputted into one end of an optical fiber and is further received with an optical receiving module provided at its other end, and thus the optical signal is transmitted.

An optical connection apparatus is used to connect the optical fiber with the optical receiving module or an optical transmitting module wherein the optical connection apparatus includes a connector with the built-in optical receiving module and the built-in optical transmitting module, and a plug inserted in a receptacle housing of the connector. The plug is attached to the end of the optical fiber. Moreover, since it is necessary to perform the processing and managing of not only optical information but also electrical signals within vehicles, the combined optical and electrical connector with the connection function of both light and electricity is known. For example, as described in the following patent documents 1-3, a configuration in which the optical transmitting module and the optical receiving module are attached to the back of receptacle housing, and a terminal for electrical use penetrating the back of receptacle housing in the side of those modules is provided is known as the combined optical and electrical connector.

The combined optical and electrical connector described in the patent documents 1 and 2 has a configuration in which the perimeter of the optical transmitting module and the optical receiving module is surrounded with a shield case, and thereby the optical transmitting module and the optical receiving module are electromagnetically shielded from their outside. Moreover, the combined optical and electrical connector described in the patent document 3 has a configuration in which a conductive tabular member is arranged between an optical connector area and an electrical connector area in the receptacle housing, and thereby electromagnetic shielding is provided between the optical connector area and the electrical connector area. The conductive tabular member has a configuration separating only the interior space of the receptacle housing.

[Patent Document 1] Japanese Unexamined Patent Publication (Kokai) No. 2001-167828

[Patent Document 2] Japanese Unexamined Patent Publication (Kokai) No. 2002-193044

[Patent Document 3] Japanese Unexamined Patent Publication (Kokai) No. 2002-365475

### DISCLOSURE OF THE INVENTION

### Problem to be Solved by the Invention

Although these combined optical and electrical connectors have a configuration in which the electromagnetic coupling between the optical connector and the electrical connector resulting from the integration of them is shielded and an optical transmitting and receiving module is shielded from its outside, there has been a state in which the shielding of the electrical connector area to electromagnetic noise from the outside is not sufficient, and the electromagnetic noise is easy to enter the electrical connector. Moreover, although the electromagnetic coupling between the optical transmitting and receiving module and the electrical connector is shielded by arranging the conductive tabular member in the receptacle housing, as described in the Patent Document 3, there has been a problem that there is no shielding effect to the electromagnetic noise from the outside, and a noise characteristic may actually become worse. It is considered as this cause that in addition to the electromagnetic noise from the outside into the electrical connector area, the electromagnetic noise reflected by the conductive tabular member further enters a plug. Furthermore, although the combined optical and electrical connector is attached to a circuit board on which integrated circuits generally used for communications, control or the like are mounted in many cases, lately the electromagnetic noise emitted from these integrated circuits or the like is not being able to be ignored from the standpoint of a frequency or a power level.

It is an object of the present invention to provide a combined optical and electrical connector capable of suppressing the electromagnetic noise from the outside further than before.

### Means for Solving Problem

A first aspect of the present invention for solving the problems described above is characterized in that a combined optical and electrical connector includes: a receptacle housing to which a plug is attached from the outside; a transmitting-side module housing section for housing a transmitting-side module at the back side of the receptacle housing; a receiving-side module housing section for housing a receiving-side module, the receiving-side module housing section being arranged in a location adjacent to the transmitting-side module housing section at the back side of the receptacle housing; an electrical terminal projecting to the back side of the receptacle housing; and an integrated shield case surrounding the receiving-side module housing section, the transmitting-side module housing section, and the electrical terminal.

A second aspect of the present invention is, in the first aspect, characterized in that the shield case has a shield wall for electromagnetically shielding between the receiving-side module housing section and the transmitting-side module housing section each other.

A third aspect of the present invention is, in the first aspect, characterized in that the shield case has a shield wall for electromagnetically shielding between the electrical terminal from the receiving-side module housing section and the transmitting-side module housing section each other.

A fourth aspect of the present invention is, in the first aspect, characterized in that the receiving-side module housing section is arranged in a forward position toward an opening side of the receptacle housing as compare with the transmitting-side module housing section.

A fifth aspect of the present invention is, in the first aspect, characterized in that, within the receptacle housing, a cylindrical first ferrule receptacle section is formed in a direction where an optical signal is transmitted to the receiving-side module, and a cylindrical second ferrule receptacle section is formed in a direction where the optical signal is transmitted from the transmitting-side module.

A sixth aspect of the present invention is, in any one of the first through fifth aspects, characterized in that at least a part in the receiving-side module housing section and the transmitting-side module housing section is composed of a conductive resin, and the shield case is composed of a metal.

### EFFECT OF THE INVENTION

According to the present invention, the receiving-side module housing section, the transmitting-side module housing section, and the electrical terminal are integrally surrounded with the shield case in the combined optical and electrical connector, and thus for example, when the combined optical and electrical connector is attached to the circuit board on which the integrated circuit and the like are mounted, it prevents the electromagnetic noise from entering from the outside to the receiving-side module, the transmitting-side module, and the electrical terminal behind the receptacle housing.

### BRIEF DESCRIPTION OF THE DRAWINGS

FIG. 1 is a sectional view showing a situation in which a combined optical and electrical connector in accordance with a first embodiment of the present invention is seen from the bottom;

FIG. 2 is a side view of the combined optical and electrical connector in accordance with the first embodiment of the present invention;

FIG. 3 is a sectional view showing a situation in which a combined optical and electrical connector in accordance with a second embodiment of the present invention is seen from the bottom;

FIG. 4 is a sectional view showing a situation in which a combined optical and electrical connector in accordance with a third embodiment of the present invention is seen from the bottom;

FIG. 5 is a sectional view showing a situation in which a combined optical and electrical connector in accordance with a fourth embodiment of the present invention is seen from the bottom;

FIG. 6 is a sectional view showing a situation in which a combined optical and electrical connector in accordance with a fifth embodiment of the present invention is seen from the bottom;

FIG. 7 is a sectional view showing a situation in which a combined optical and electrical connector in accordance with a sixth embodiment of the present invention is seen from the bottom;

FIG. 8 is a sectional view showing a situation in which a combined optical and electrical connector in accordance with a seventh embodiment of the present invention is seen from the bottom; and

FIG. 9 is a sectional view showing a situation in which a combined optical and electrical connector in accordance with an eighth embodiment of the present invention is seen from the bottom.

### EXPLANATIONS OF LETTERS OR NUMERALS

1: Combined optical and electrical connector
2: Opening
3: Receptacle housing
4: Plug connection space
5: Terminal fixing section
6: Electrical terminal
7: Receiving-side optical coupling section
7a: First ferrule receptacle section
7b: Receiving-side module coupling section
8: Transmitting-side optical coupling section
8a: Second ferrule receptacle section
8b: Transmitting-side module coupling section
8c: Transmitting-side module housing section
9: Receiving-side module housing socket
10: Receiving-side sealing member
11: Receiving-side module
12: Transmitting-side sealing member
13: Transmitting-side lens
14: Transmitting-side module
15: Transmitting-side IC
16, 26, 36: Shield case
16a: Optical module shield section
16b: Electrical terminal shield section
16c: Module coupling region shield section
16d, 16e: Shield wall
16f: Step section
16g, 16h: Shield wall

### BEST MODE(S) FOR CARRYING OUT THE INVENTION

Hereinafter, embodiments of the present invention will be described in detail based on the drawings.

### First Embodiment

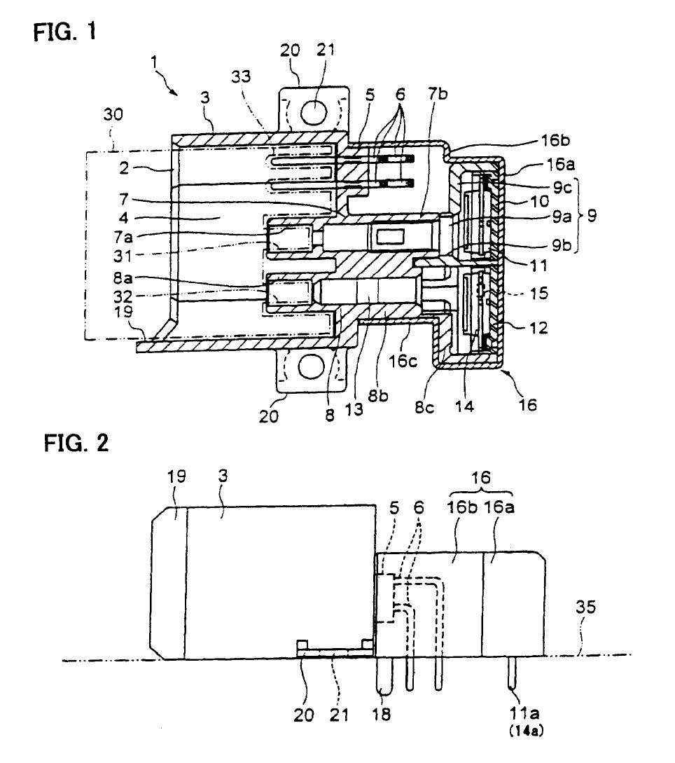

FIG. 1 is a sectional view in which a combined optical and electrical connector in accordance with the first embodiment of the present invention is seen from the bottom, and FIG. 2 is a side view showing the combined optical and electrical connector in accordance with the first embodiment of the present invention.

An combined optical and electrical connector 1 shown in FIGS. 1 and 2 has a receptacle housing 3 having an opening 2 at one end (a front), and a plug connection space 4 leading to the opening 2 is formed inside the receptacle housing 3. The plug connection space 4 has a configuration in which a plug 30 is fitted through the opening 2.

The receptacle housing 3 is laterally separated into an electrical connector area and an optical connector area, and a thick-walled terminal fixing section 5 is protrudedly provided backward at the other end face (back face) of the electrical connector area. A plurality of electrical terminals 6 penetrating from the inside of the plug connection space 4 to the outside of the back face of the receptacle housing 3 are attached to the terminal fixing section 5. As for the electrical terminal 6, for example, four terminals are arranged spaced apart in both top and bottom, left and right, and the electrical terminal 6 has a length and a direction allowing the insertion into a jack 33 of the plug 30 in the plug connection space 4, while it also has a structure in which it is bent into an L shape behind the back face of the receptacle housing 3, and further is protruded below the bottom of the receptacle housing 3.

Moreover, at the other end (back face) of the optical connector area of the receptacle housing 3, a hollow receiving-side optical coupling section 7 and a hollow transmitting-side optical coupling section 8 are adjacently formed in parallel with each other, from the inside to the outside of the receptacle housing 3. A cylindrical first ferrule receptacle section 7a having a size for fitting a ferrule 31 for a first optical fiber at the tip of the plug 30 within the plug connection space 4 is formed at one end of the receiving-side optical coupling section 7, whereas a receiving-side module coupling section 7b with the cylindrical interior is formed at the other end of the receiving-side optical coupling section 7.

A receiving-side module housing socket 9 formed of a conductive resin is connected to the opening of the back end of the receiving side module coupling section 7b. The end of the receiving-side module housing socket 9 is fitted into the receiving-side optical coupling section 7b, and has a connection section 9b in which an optical transmission hole 9a for transmitting an optical signal transmitted in the receiving-side module coupling section 7 is formed. Meanwhile, the other end of the receiving-side module housing socket 9 has a receiving-side module housing section 9c which laterally extends so as to be located behind the electrical terminal 6.

The opening of the back end of the receiving-side module housing section 9c is blocked with a receiving-side sealing member 10 formed of an insulating resin or a conductive resin, and a receiving-side module 11 is attached to one surface of the receiving-side sealing member 10 which faces the receiving-side module housing section 9c. A light receiving device (not shown) is provided in the receiving-side module 11, and is arranged so that its photosensitive surface is located on an extension of an optical axis in the receiving-side module coupling section 7. Moreover, a conductive terminal 11a penetrating the undersurface of the receiving-side module housing socket 9 and projecting outside is attached to the lower part of the receiving-side module 11, as shown in FIG. 2.

A cylindrical second ferrule receptacle section 8a having a size for fitting a second optical fiber ferrule 32 at the tip of the plug 30 within the plug connection space 4 is formed at one end of the transmitting-side optical coupling section 8. Meanwhile, a transmitting-side module coupling section 8b having almost the same length as the receiving-side module coupling section 7b and with the cylindrical interior is formed at the other end of the transmitting-side optical coupling section 8 and behind the receptacle housing 3. A transmitting-side lens 13 is fitted into an optical transmission hole in the transmitting-side module coupling section 8b. A transmitting-side module housing section 8c for housing a transmitting-side module 14 is formed at the back end of the transmitting-side module coupling section 8b to have a portion extending in the opposite side to the receiving-side module coupling section 7.

The opening is formed at the back end of the transmitting-side module housing section 8c, and the opening is blocked with a transmitting-side sealing member 12 formed of an insulating resin or a conductive resin. A transmitting-side module 14 is attached to one surface of the transmitting-side sealing member 12 which faces the transmitting-side module housing section 8c. A light emitting device (not shown) is incorporated in the transmitting-side module 14, and the transmitting-side module 14 is arranged so that the light emitting surface of the light emitting device may be located on an extension of an optical axis in the transmitting-side optical coupling section 8. Moreover, a conductive terminal 14a penetrating through and projecting from the undersurface of the transmitting-side optical coupling section 8 is attached to the transmitting-side module 14. Furthermore, a transmitting-side IC 15 for converting an electrical signal to an optical signal is incorporated in the transmitting-side module 14.

The back end of the transmitting-side module housing section 8c is aligned on the same line in the back-and-forth direction as the back end of the receiving-side module housing section 9c. Accordingly, the transmitting-side sealing member 12 and the receiving-side sealing member 10 for blocking up the back end opening sections of the transmitting-side module housing section 8c and the receiving-side module housing section 9c, respectively, are attached side-by-side so that they may be substantially aligned on the same line in the back-and-forth direction.

Incidentally, the receiving-side module coupling section 7 equipped with the first ferrule receptacle section 7a and the receiving-side optical coupling section 7b and the transmitting-side optical coupling section 8 equipped with the second ferrule receptacle section 8a, the transmitting-side module coupling section 8b, and the transmitting-side module housing section 8c are formed respectively of an insulating resin together with the receptacle housing 3 and the terminal fixing section 5 in an integrated fashion. The insulating resin includes, for example, a polybutylene terephthalate (PBT) resin containing glass filler. Incidentally, the conductive resin includes, for example, a PBT resin containing carbon filler.

The outer faces of the transmitting-side module coupling section 8b, the transmitting-side module housing section 8c, the receiving-side module housing section 9c, and the electrical terminal 6 behind the plug connection space 4 of the receptacle housing 3, except for their front faces and undersurfaces, are continuously covered and surrounded with a metal shield case 16. An optical module shield section 16a of the shield case 16 covers the top face, side face, and back face of each of the transmitting-side module housing section 8c and the receiving-side module housing section 9c, as well as the front face of the portion projected to the side direction in the transmitting-side module housing sections 8c. Moreover, an electrical terminal shield section 16b of the shield case 16 covers the electrical terminal 6 at a space from its side, back, and upper regions except for, in the circumference of the electrical terminal 6, its lower region and the portion which is not surrounded with the receiving-side optical coupling section 7b and the receiving-side module housing section 9c. Furthermore, a module coupling region shield section 16c of the shield case 16 covers the top faces of the transmitting-side module coupling section 8b and the receiving-side optical coupling section 7b, and the side face of the transmitting-side module coupling section 8b.

The optical module shield section 16a, the electrical terminal shield section 16b, and the module coupling region shield section 16c have, for example, a box-like shape produced by bending a brass metal plate, and they are electromagnetically connected to each other. Incidentally, in FIGS. 1 and 2, a reference numeral 18 represents a positioning pin formed near the center of the back face of the receptacle housing 3, a reference numeral 19 a guide piece projecting in the front region from one side face of the receptacle housing 3, a reference numeral 20 a screw clamp fixing section projecting in the side regions from the both-side faces of the receptacle housing 3, and a reference numeral 21a threaded hole formed in a screw clamp fixing section 20, respectively.

As shown in FIG. 2, the combined optical and electrical connector 1 (not shown) having the above configuration is attached to a circuit board 35 on which the integrated circuit and the like (not shown) are mounted. When the plug 30 is connected to the combined optical and electrical connector 1, the plug 30 is inserted into the plug connection space 4 of the receptacle housing 3 while the side section of the tip of the plug 30 is touched to a guide piece 19 in the front of the receptacle housing 3, and accordingly, as shown in the two-dot chain line in FIG. 1, one end of the electrical terminal 6 is inserted in the jack 33 of the plug 30, and further the ferrule 31 for the first optical fiber is fitted into the first ferrule receptacle section 7a and the ferrule 32 for the second optical fiber is fitted into the second ferrule receptacle section 8a.

This allows electrical parts (not shown) on the circuit board 35 to be electrically connected to the outside via the electrical terminal 6, the jack 33, and a wiring (not shown) on the circuit board 35. Moreover, it becomes possible that an optical signal passing through the ferrule 31 for the first optical fiber is propagated in the receiving-side module coupling section 7 and is inputted into the light receiving device of the receiving-side module 11, and further it becomes possible that an optical signal outputted from the transmitting-side module 14 is propagated in the transmitting-side optical coupling section 8 and is inputted into the ferrule 32 for the second optical fiber.

In such a state, the shield case 16 formed of the metal has a configuration in which areas containing the receiving-side optical coupling section 7, the transmitting-side optical coupling section 8, the receiving-side module housing socket 9, the receiving-side module 11, the transmitting-side module 14, and the electrical terminal 6, except for the lower side and the front side behind the receptacle housing 3, are wholly covered from outside circumference. Since this prevents the electromagnetic noise from the circuit board 35 and the other outside from entering the receiving-side module 11, the malfunction of the receiving-side module 11 caused by the external noise can be avoided.

Moreover, the metal shield case 16 surrounds the receiving-side module 11 and the transmitting-side module 14 from the circumference and the upper region and further surrounds the perimeter and the upper region of the electrical terminal 6 behind the receptacle housing 3, and thus the receiving-side module 11, the transmitting-side module 14, and the electrical terminal 6 are shielded from the external electromagnetic noise. This prevents the electromagnetic noise from the circuit board 35 and the other outside from entering the receiving-side module 11, the transmitting-side module 14, and the electrical terminal 6 behind the plug connection space 4 of the receptacle housing 3 and prevents the reflection of the electromagnetic noise in the interior from occurring. Furthermore, an electrical terminal shield section 16b surrounding the electrical terminal 6 from the outside behind the receptacle housing 3 also has a function of preventing foreign matter from the outside from entering by cooperating with the receiving-side module housing section 9c.

Moreover, the receiving-side module housing socket 9 and the receiving-side sealing member 10 surround the receiving-side module 11 except for the optical transmission hole 9a and its periphery, and thus when the receiving-side module housing socket 9 and the receiving-side sealing member 10 are formed of the conductive resin, the receiving-side module 11 will be electromagnetically shielded from the outside by the shield case 16, the receiving-side module housing socket 9, and the receiving-side sealing member 10. Since this prevents the electromagnetic noise from the circuit board 35 and the other outside from entering the receiving-side module 11, the malfunction of the receiving-side module 11 caused by the external noise can be more effectively avoided.

Incidentally, when the receiving-side module housing socket 9 and the receiving-side sealing member 10 are formed of the conductive resin, these and the shield case 16 composed of the metal are used for purpose of the electromagnetic shielding, but a shielding effect depends on the frequency band of the noise because their materials are different. In other words, the receiving-side module housing socket 9 and the receiving-side sealing member 10 composed of the conductive resin are used for the electromagnetic shielding at the comparatively low frequency side of, for example, 100 MHz or less, and, the metal shield case 16 is used for the electromagnetic shielding at the comparatively high frequency side of, for example, 400 MHz or more. Accordingly, in an area where the arrangement areas of the receiving-side module housing socket 9 and the receiving-side sealing member 10 and the arrangement area of the shield case 16 are overlapped, these shielding effects will be superimposed.

Incidentally, in the above example, the circumference of the receiving-side module 11 has a structure surrounded with the conductive resin, but the circumference of both or either of the transmitting-side module 14 and the receiving-side module 11 may have a structure surrounded with the conductive resin. Moreover, when the electromagnetic shielding of the comparatively low frequency side is not important and so on, the circumference of both the transmitting-side module 14 and the receiving-side module 11 may have a structure surrounded with the insulating resin.

### Second Embodiment

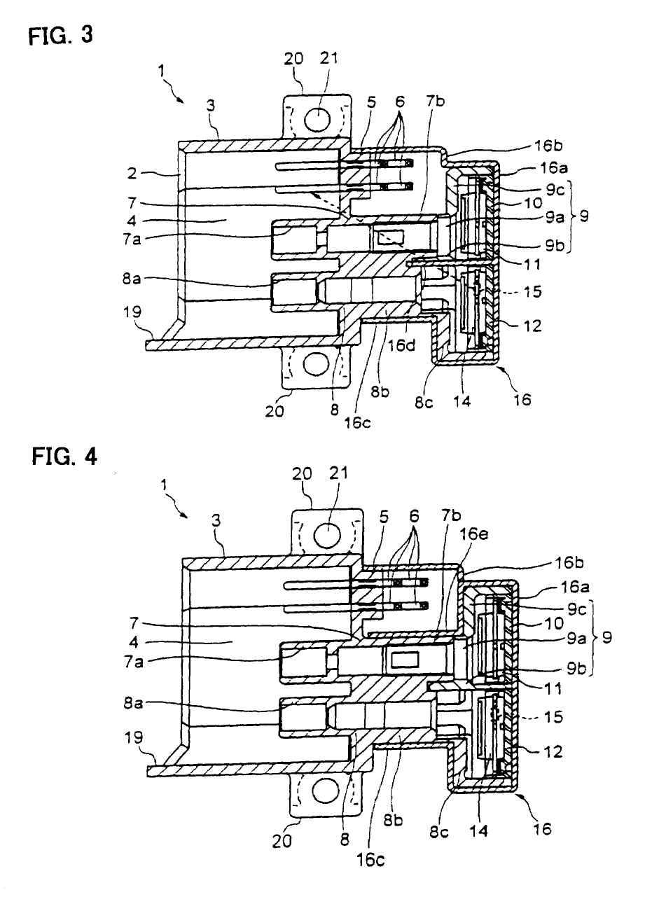

FIG. 3 is a sectional view in which a combined optical and electrical connector in accordance with a second embodiment of the present invention is seen from the bottom. In FIG. 3, the same symbol as that in FIG. 1 represents the same element. In FIG. 3, the combined optical and electrical connector 1 includes the receptacle housing 3, the terminal fixing section 5, the electrical terminal 6, the receiving-side module coupling section 7, the transmitting-side optical coupling section 8, the receiving-side module housing socket 9, the receiving-side sealing member 10, the receiving-side module 11, the transmitting-side sealing member 12, a transmitting-side lens 13, the transmitting-side module 14, the shield case 16, a positioning pin 18, the guide piece 19, and the screw clamp fixing section 20 or the like, which have the same configurations as those in the first embodiment.

The shield case 16 not only has the optical module shield section 16a, the electrical terminal shield section 16b, and the module coupling region shield section 16c like the first embodiment, but also has a first shield wall 16d formed of metal, such as brass, which is arranged at the back side of the receptacle housing 3 and is fitted in between the receiving-side module coupling section 7 and the transmitting-side optical coupling section 8. The first shield wall 16d is electromagnetically connected to the optical module shield section 16a, the electrical terminal shield section 16b, and the module coupling region shield section 16c. The first shield wall 16d has a configuration and size for shielding the electromagnetic noise from the transmitting-side IC 15 in the transmitting-side module 14 to the electrical terminal 6 in the receptacle housing 3.

Incidentally, the first shield wall 16d may be integrally formed with the optical module shield section 16a or the like by processing a metal plate, or may be separately formed. According to the combined optical and electrical connector 1 of the above configuration, like the first embodiment, the electromagnetic noise entering from the outside to the receiving-side module 11, the transmitting-side module 14, and the electrical terminal 6 behind the plug connection space 4 of the receptacle housing 3 is shielded by the shield case 16.

Moreover, the first shield wall 16d between the receiving-side module coupling section 7 and the transmitting-side optical coupling section 8 shields the electromagnetic noise emitted from the transmitting-side IC 15 in the transmitting-side module 14 to the electrical terminal 6, thereby enabling the sufficient shielding of the electromagnetic noise to the electrical terminal 6 (an arrow in FIG. 3) by cooperating with the shield case 16. Furthermore, the first shield wall 16d can electromagnetically shield between the transmitting-side module 14 and the receiving-side module 15. Incidentally, when the electromagnetic noise from the transmitting-side IC 15 is sufficiently smaller than that emitted from the circuit board 35, the first shield wall 16d need not be provided as shown in the first embodiment.

### Third Embodiment

FIG. 4 is a sectional view in which a combined optical and electrical connector in accordance with a third embodiment of the present invention is seen from the bottom. In FIG. 4, the same symbol as that in FIG. 1 represents the same element. In FIG. 4, the combined optical and electrical connector 1 includes the receptacle housing 3, the terminal fixing section 5, the electrical terminal 6, the receiving-side module coupling section 7, the transmitting-side optical coupling section 8, the receiving-side module housing socket 9, the receiving-side sealing member 10, the receiving-side module 11, the transmitting-side sealing member 12, the transmitting-side lens 13, the transmitting-side module 14, the shield case 16, the positioning pin 18, the guide piece 19, and the screw clamp fixing section 20 or the like, which have the same configurations as those in the first embodiment.

The shield case 16 not only has the optical module shield section 16a, the electrical terminal shield section 16b, and the module coupling region shield section 16c like the first embodiment, but also has a second shield wall 16e covering continuously the front face of the portion projected to the side region in the receiving-side module housing section 9c and the side face of the receiving-side optical coupling section 7b.

The optical module shield section 16a, the electrical terminal shield section 16b, the module coupling region shield section 16c, and the second shield wall 16e have, for example, a box-like shape produced by bending the brass metal plate and they are electromagnetically connected to each other. Accordingly, the electrical terminal 6 becomes a state in which it is surrounded, except for its front and lower regions, with the second shield section 16c and the electrical terminal shield section 16b, thereby becoming a state in which it is electromagnetically shielded from the outside as well as the receiving-side module 11 and the transmitting-side module 14.

According to the combined optical and electrical connector 1 of the above configuration, like the first embodiment, the electromagnetic noise entering from the outside to the receiving-side module 11, the transmitting-side module 14, and the electrical terminal 6 behind the receptacle housing 3 is shielded by the shield case 16. Moreover, the second shield wall 16e covering the front face of the portion projected to the side region in the receiving-side module housing section 9c and the side face of the receiving-side optical coupling section 7b can shield the electrical terminal 6 from the electromagnetic noise emitted from the transmitting-side module 14 and the receiving-side module 11.

### Fourth Embodiment

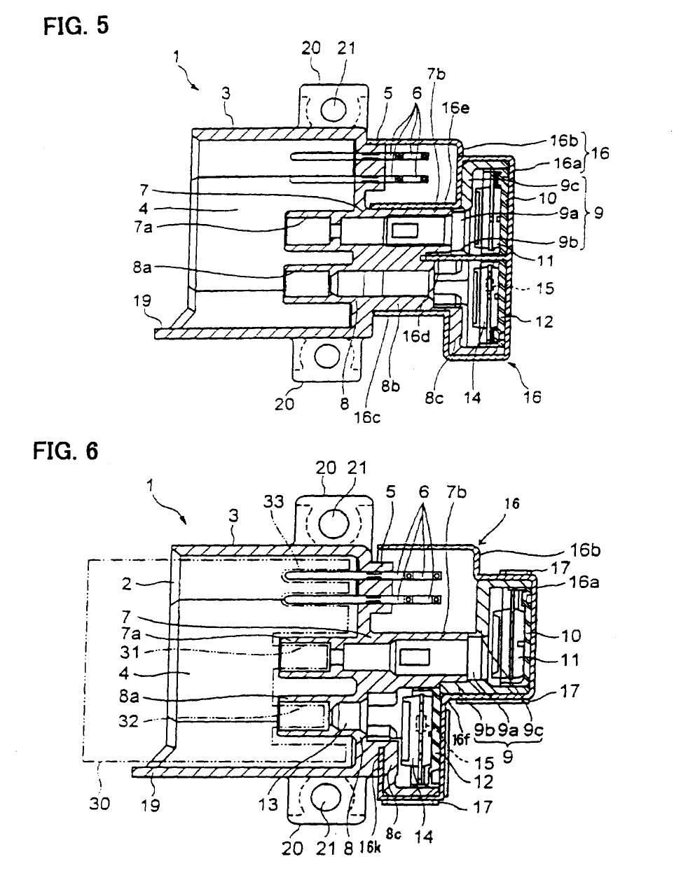

FIG. 5 is a sectional view in which a combined optical and electrical connector in accordance with a fourth embodiment of the present invention is seen from the bottom. In FIG. 5, the same symbol as that in FIG. 1, FIG. 3, and FIG. 4 represents the same element. In FIG. 5, the combined optical and electrical connector 1 includes the receptacle housing 3, the terminal fixing section 5, the electrical terminal 6, the receiving-side module coupling section 7, the transmitting-side optical coupling section 8, the receiving-side module housing socket 9, the receiving-side sealing member 10, the receiving-side module 11, the transmitting-side sealing member 12, the transmitting-side lens 13, the transmitting-side module 14, the shield case 16, the positioning pin 18, the guide piece 19, and the screw clamp fixing section 20 or the like, which have the same configurations as those in the first embodiment.

The shield case 16 not only has the optical module shield section 16a, the electrical terminal shield section 16b, and the module coupling region shield section 16c like the first embodiment, but also has the first shield wall 16d fitted in between the receiving-side module coupling section 7 and the transmitting-side optical coupling section 8 in a manner similar to the second embodiment, and the second shield wall 16e covering the front face of the portion projected to the side region in the receiving-side module housing section 9c and the side face of the receiving-side optical coupling section 7b in a manner similar to the third embodiment.

In the combined optical and electrical connector having such a shield case 16, the electromagnetic noise possibly emitted from the transmitting-side module 14 and the receiving-side module 15 to the electrical terminal 6 is shielded by the first and second shield walls 16d and 16e, thereby enabling to prevent the electromagnetic noise from entering the electrical terminal 6. Furthermore, the first shield wall 16d can electromagnetically shield between the transmitting-side module 14 and the receiving-side module 15. Furthermore, the above shield case 16 can individually shield the electromagnetic noise entering from the outside to the receiving-side module 11, the transmitting-side module 14, and the electrical terminal 6, respectively, in the back of the receptacle housing 3.

### Fifth Embodiment

FIG. 6 is a sectional view in which a combined optical and electrical connector in accordance with a fifth embodiment of the present invention is seen from the bottom. In FIG. 6, the same symbol as that in FIG. 1 represents the same element. In FIG. 6, the combined optical and electrical connector 1 has the receptacle housing 3, the terminal fixing section 5, and the electrical terminal 6 which have the same configurations as those of the first embodiment. Moreover, the receiving-side module coupling section 7 and the transmitting-side optical coupling section 8 extended in the back-and-forth direction are adjacently formed, respectively, in parallel in the back side of the receptacle housing 3.

Like the first embodiment, the receiving-side module coupling section 7 has the cylindrical first ferrule receptacle section 7a formed inside the receptacle housing 3 and the cylindrical receiving-side optical coupling section 7b formed behind the back face of the receptacle housing 3. Moreover, the connection section 9b of the receiving-side module housing socket 9 accommodating the receiving-side module 11 is connected to the opening section of the rear of the receiving-side optical coupling section 7b in a manner similar to the first embodiment, and is attached so that the axis of the optical transmission hole 9a may be positioned in coincidence with the inside axis of the receiving-side module coupling section 7. Furthermore, the receiving-side module 11 is attached in the receiving-side module housing section 9c of the receiving-side module housing socket 9, and the receiving-side sealing member 10 is fitted in the opening section of the back end.

In the transmitting-side optical coupling section 8, the cylindrical second ferrule receptacle section 8a having the size for fitting the second optical fiber ferrule 32 at the tip of the plug within the plug connection space 4 is formed at one end. Meanwhile, the transmitting-side module housing section 8c for housing the transmitting-side module 14 behind the receptacle housing 3 is formed at the other end. The transmitting-side module housing section 8c is arranged at the front position, or the opening section 2 side of the receptacle housing, relative to the receiving-side module housing section 9c, and the transmitting-side sealing member 12 is fitted in the opening of the rear. There exists a step between the back end of the transmitting-side module housing section 8c and that of the receiving-side module housing section 9c in such configuration.

The receiving-side module housing section 8c, the receiving-side module housing socket 9, and the electrical terminal 6 are surrounded with the shield case 16 behind the receptacle housing 3 in a manner similar to the first embodiment. The shield case 16 has a step section 16f whose configuration is adjusted to the step between the transmitting-side module housing section 8c and the receiving-side module housing section 9c, in addition to the configuration shown in the first embodiment. Moreover, the shield case 16 has a fitting section 16k, which is fitted in the slot of the front part of the transmitting-side module housing section 8c, and shields the slanting front. Incidentally, in FIG. 6, a reference numeral 17 in the figure represents a frame body for pressing down the shield case 16 from the outside.

In the combined optical and electrical connector having the above shield case 16, the receiving-side module housing socket 9 and the receiving-side sealing member 10 formed of the insulating resin or the conductive resin surround the receiving-side module 11 except for the optical transmission hole 9a and its periphery in a manner similar to the first embodiment. When the receiving-side module housing socket 9 and the receiving-side sealing member 10 are formed of the conductive resin, this prevents the electromagnetic noise from the circuit board 35 and the other outside from entering the receiving-side module 11, and thus the malfunction of the receiving-side module 11 caused by the external noise can be avoided.

The shield case 16 formed of the metal has a structure covering the region containing the receiving-side module coupling section 7, the transmitting-side optical coupling section 8, the receiving-side module housing socket 9, the receiving-side module 11, the transmitting-side module 14, and the electrical terminal 6 except for the lower and front sides behind the receptacle housing 3, from the outside circumference. Moreover, the metal shield case 16 surrounds the receiving-side module 11 and the transmitting-side module 14 from the circumference and the upper region and further surrounds the electrical terminal 6 behind the receptacle housing 3 from one side region and the upper region, and thus the receiving-side module 11, the transmitting-side module 14, and the electrical terminal 6 can be shielded from the external electromagnetic noise.

Moreover, the transmitting-side module housing section 8c is located at the front to the receiving-side module housing section 9c, and the step section 16f of the shield case 16 covering the side face of the receiving-side module housing section 9c and the back face of the transmitting-side module housing section 8c shields electromagnetically between the receiving-side module 11 in the receiving-side module housing section 9c and the transmitting-side modules 14 in the transmitting-side module housing section 8c, and thus the mutual influence of the electromagnetic noise can be prevented. This prevents the electromagnetic noise from the other outside such as the circuit board 35 from entering the receiving-side module 11, the transmitting-side module 14, and the electrical terminal 6 behind the plug connection space 4 of the receptacle housing 3 and prevents the reflection of the electromagnetic noise in the interior from occurring.

### Sixth Embodiment

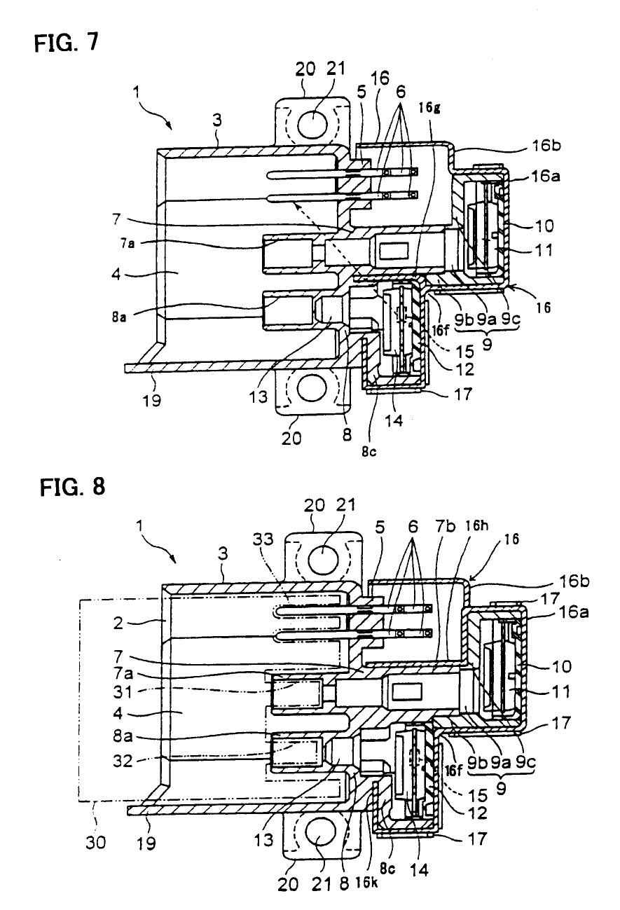

FIG. 7 is a sectional view in which a combined optical and electrical connector in accordance with a sixth embodiment of the present invention is seen from the bottom. In FIG. 7, the same symbol as that in FIG. 6 represents the same element. In FIG. 7, the combined optical and electrical connector 1 includes the receptacle housing 3, the terminal fixing section 5, the electrical terminal 6, the receiving-side module coupling section 7, the transmitting-side optical coupling section 8, the receiving-side module housing socket 9, the receiving-side sealing member 10, the receiving-side module 11, the transmitting-side sealing member 12, transmitting-side lens 13, the transmitting-side module 14, the shield case 16, a frame body 17, the positioning pin 18, the guide piece 19, and the screw clamp fixing section 20 or the like, which have the same configurations as those in the fifth embodiment.

Furthermore, a first shield wall 16g formed of the metal, such as brass, is fitted in the slot between the receiving-side module coupling section 7 and the transmitting-side optical coupling section 8 at the back side of the receptacle housing 3, and the first shield wall 16g is electromagnetically connected to the shield case 16. The first shield wall 16g has a configuration and size for shielding the electromagnetic noise from the transmitting-side IC 15 in the transmitting-side module 14 to the electrical terminal 6.

According to the combined optical and electrical connector 1 of the above configuration, like the first embodiment, the electromagnetic noise entering from the outside to the receiving-side module 11, the transmitting-side module 14, and the electrical terminal 6 behind the plug connection space 4 of the receptacle housing 3 is shielded by the shield case 16. Moreover, the first shield wall 16g between the receiving-side module coupling section 7 and the transmitting-side optical coupling section 8 shields the electromagnetic noise emitted from the transmitting-side IC 15 in the transmitting-side module 14 to the electrical terminal 6 in the plug connection space 4 (an arrow in FIG. 7), thereby enabling the sufficient shielding of the electromagnetic noise to the electrical terminal 6.

### Seventh Embodiment

FIG. 8 is a sectional view in which a combined optical and electrical connector in accordance with a seventh embodiment of the present invention is seen from the bottom. In FIG. 8, the same symbol as that in FIG. 6 represents the same element. In FIG. 8, the combined optical and electrical connector 1 includes the receptacle housing 3, the terminal fixing section 5, the electrical terminal 6, the receiving-side module coupling section 7, the transmitting-side optical coupling section 8, the receiving-side module housing socket 9, the receiving-side sealing member 10, the receiving-side module 11, the transmitting-side sealing member 12, transmitting-side lens 13, the transmitting-side module 14, the shield case 16, the frame body 17, the positioning pin 18, the guide piece 19, and the screw clamp fixing section 20 or the like, which have the same configurations as those in the fifth embodiment.

Moreover, the shield case 16 not only has the optical module shield section 16a, the electrical terminal shield section 16b, and the module coupling region shield section 16c like the fifth embodiment, but also has a second shield wall 16h covering the front face of the portion projected to the side region in the receiving-side module housing section 9c and the side face of the receiving-side optical coupling section 7b at the back side of the receptacle housing 3.

The optical module shield section 16a, the electrical terminal shield section 16b, the module coupling region shield section 16c, and the second shield wall 16h have, for example, a box-like shape produced by bending the brass metal plate and they are electromagnetically connected to each other. According to the combined optical and electrical connector 1 of the above configuration, like the fifth embodiment, the electromagnetic noise entering from the other outside such as the circuit board 35 to the receiving-side module 11, the transmitting-side module 14, and the electrical terminal 6 behind the plug connection space 4 of the receptacle housing 3 is shielded by the shield case 16. Moreover, the second shield wall 16h covering the front face of the portion projected to the side region in the receiving-side module housing section 9c and the side face of the receiving-side optical coupling section 7b can shield the electrical terminal 6 from the electromagnetic noise emitted from the transmitting-side module 14 and the receiving-side module 11.

### Eighth Embodiment

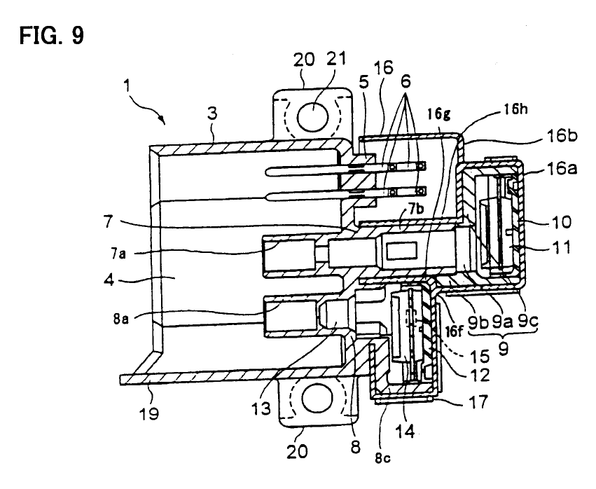

FIG. 9 is a sectional view in which a combined optical and electrical connector in accordance with an eighth embodiment of the present invention is seen from the bottom. In FIG. 9, the same symbol as that in FIG. 6, FIG. 7, and FIG. 8 represents the same element. In FIG. 9, the combined optical and electrical connector 1 includes the receptacle housing 3 which has the same configuration as the first embodiment, the terminal fixing section 5, the electrical terminal 6, the receiving-side optical coupling section 7, the transmitting-side optical coupling section 8, the receiving-side module housing socket 9, the receiving-side sealing member 10, the receiving-side module 11, the transmitting-side sealing member 12, the transmitting-side lens 13, the transmitting-side module 14, the shield case 16, the positioning pin 18, the guide piece 19, the screw fixing section 20, and the like.

The shield case 16 not only has the optical module shield section 16a, the electrical terminal shield section 16b, and the module coupling region shield section 16c like the fifth embodiment, but also has the first shield wall 16g fitted in between the receiving-side module coupling section 7 and the transmitting-side optical coupling section 8 in a manner similar to the sixth embodiment, and the second shield wall 16h covering the front face of the portion projected to the side region in the receiving-side module housing section 9c and the side face of the receiving-side optical coupling section 7b in a manner similar to the seventh embodiment.

In the combined optical and electrical connector having such a shield case 16, the electromagnetic noise emitted from the transmitting-side module 14 and the receiving-side module 15 to the electrical terminal 6 is shielded by the first and second shield walls 16g and 16h, thereby enabling to prevent the electromagnetic noise from entering the electrical terminal 6. Furthermore, the above shield case 16 can individually shield the electromagnetic noise entering from the outside to the receiving-side module 11, the transmitting-side module 14, and the electrical terminal 6, respectively, in the back of the receptacle housing 3.

Incidentally, it is needless to say that the embodiment of the combined optical and electrical connector in accordance with the present invention is not limited to each of the embodiments described above. For example, the shield case 16 may be extendedly provided on the side of the receptacle housing 3 or the like depending on the arrangement of the integrated circuits or the like on the circuit board 35.

### INDUSTRIAL APPLICABILITY

It is an object of the present invention to provide the combined optical and electrical connector capable of suppressing the electromagnetic noise from the outside further than before.

1. An combined optical and electrical connector, comprising:
a receptacle housing to which a plug is attached from the outside;
a transmitting-side module housing section for housing a transmitting-side module at the back side of the receptacle housing;
a receiving-side module housing section for housing a receiving-side module, the receiving-side module housing section being arranged in a location adjacent to the transmitting-side module housing section at the back side of the receptacle housing;
an electrical terminal projecting to the back side of the receptacle housing; and
an integrated shield case surrounding the receiving-side module housing section, the transmitting-side module housing section, and the electrical terminal.

2. The combined optical and electrical connector according to claim 1, wherein the shield case has a shield wall for electromagnetically shielding between the receiving-side module housing section and the transmitting-side module housing section each other.

3. The combined optical and electrical connector according to claim 1, wherein the shield case has a shield wall for electromagnetically shielding the electrical terminal from the receiving-side module housing section and the transmitting-side module housing section.

4. The combined optical and electrical connector according to claim 1, wherein the receiving-side module housing section is arranged in a front position on an opening side of the receptacle housing to the transmitting-side module housing section.

5. The combined optical and electrical connector according to claim 1, wherein within the receptacle housing, a cylindrical first ferrule receptacle section is formed in a direction where an optical signal is transmitted to the receiving-side module, and a cylindrical second ferrule receptacle section is formed in a direction where the optical signal is transmitted from the transmitting-side module.

6. The combined optical and electrical connector according to any one of claims 1 through 5, wherein at least a part in the receiving-side module housing section and the transmitting-side module housing section is composed of a conductive resin, and the shield case is composed of a metal.
